(19) United States
(12) Patent Application Publication
(10) Pub. No.: US 2016/0148178 A1
(43) Pub. Date: May 26, 2016

(54) SCREEN DISPLAY PROGRAM

(71) Applicant: NOMURA RESEARCH INSTITUTE, LTD., Tokyo (JP)

(72) Inventors: Hitoshi YANO, Tokyo (JP); Koji NAKAJIMA, Tokyo (JP); Koji TERADA, Tokyo (JP)

(73) Assignee: NOMURA RESEARCH INSTITUTE, LTD., Tokyo (JP)

(21) Appl. No.: 15/013,344

(22) Filed: Feb. 2, 2016

Related U.S. Application Data
(63) Continuation of application No. PCT/JP2013/071149, filed on Aug. 5, 2013.

(51) Int. Cl. G06Q 20/10; G06F 3/0482; G06Q 20/32

(52) U.S. Cl. CPC G06Q 20/108; G06Q 20/3255; G06F 3/0482

(57) ABSTRACT

A screen display program causes a mobile terminal communicably connected to a server to execute an initial message acquisition procedure that includes acquiring a first message group from among a plurality of messages from the server, an initial message display procedure that includes displaying messages of the first message group sequentially according to an operation of a user, an additional message acquisition procedure that includes acquiring, when a number of undisplayed messages to be displayed sequentially among the messages of the first message group becomes less than or equal to a predetermined number, a second message group different from the first message group from among the plurality of messages from the server, and an additional message display procedure that includes displaying messages of the second message group sequentially following the messages of the first message group.

### CROSS-REFERENCE TO RELATED APPLICATIONS

This application is a continuation application, filed under 35 U.S.C. §111(a), of International Application PCT/JP2013/071149 filed on Aug. 5, 2013, the disclosure of which is incorporated herein by reference.

### BACKGROUND

The popularization of mobile terminals, such as smartphones increases opportunities to use a variety of services, such as an Internet banking system from mobile terminals (e.g., JP 2012-247927 A). In such an Internet banking system, various notices (messages) from a bank are often notified to a user after login.

FIG. 7A and FIG. 7B are diagrams illustrating an example of screens for checking a message in an Internet banking system. For example, as illustrated in FIG. 7A, a list of messages to a user is displayed after login. When the user selects one message from this list, a message content (the text of a notice) is displayed as illustrated in FIG. 7B.

On an area 700 illustrated in FIG. 7B, the user can select a “next” area 700 to display multiple messages sequentially. However, since the message is acquired from the Internet banking system after the “next” is selected, a time lag may occur from the selection of the “next” area until the message is displayed. Particularly, when the Internet banking system is used on a mobile terminal, such a time lag may be long because of a low communication rate.

### SUMMARY

Various embodiments described herein have been made in view of the circumstances discussed above, and it is an object thereof to improve operability in checking multiple messages acquired via a network.

A screen display program according to various embodiments described herein causes a mobile terminal communicably connected to a server to execute an initial message acquisition procedure that includes acquiring a first message group from among a plurality of messages from the server, an initial message display procedure that includes displaying messages of the first message group sequentially according to an operation of a user, an additional message acquisition procedure that includes acquiring, when a number of undisplayed messages to be displayed sequentially among the messages of the first message group becomes less than or equal to a predetermined number, a second message group different from the first message group from among the plurality of messages from the server, and an additional message display procedure that includes displaying messages of the second message group sequentially following the messages of the first message group.

A method according to various embodiments described herein is performed in a mobile terminal with a touch screen display that is communicably connected to a server and includes acquiring a first message group from among a plurality of messages from the server, displaying messages of the first message group sequentially according to an operation of a user, acquiring, when a number of undisplayed messages to be displayed sequentially among the messages of the first message group becomes less than or equal to a predetermined number, a second message group different from the first message group from among the plurality of messages from the server, and displaying messages of the second message group sequentially following the messages of the first message group.

According to various embodiments described herein, the term “block” does not merely relate to a physical device, but also includes a case where the function of the “block” is implemented by software. Further, the function of one “block” or device may be implemented by two or more physical devices, or the functions of two or more “blocks” or devices may be implemented by one physical device.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram of the configuration of an information processing system according to an embodiment;

FIG. 2 is a diagram of the hardware configuration of a mobile terminal;

FIG. 3 is a diagram of functional blocks in the mobile terminal;

FIG. 4 is a diagram of the hardware configuration of an Internet banking system;

FIG. 5 is a diagram of functional blocks in the Internet banking system;

FIG. 6A is a diagram of a screen of a message list displayed on the mobile terminal;

FIG. 6B is a diagram of a screen on which the text of the seventh message is displayed;

FIG. 6C is a diagram of a screen on which the text of the ninth message is displayed;

FIG. 6D is a diagram of a screen on which the text of the tenth message is displayed;

FIG. 6E is a diagram of a screen on which the text of the eleventh message is displayed;

FIG. 6F is a diagram of a screen of a message list containing the eleventh through twentieth messages;

FIG. 7A is a diagram of a screen of a message list in a general Internet banking system; and

FIG. 7B is a diagram of a screen on which the text of a message is displayed.

### DETAILED DESCRIPTION

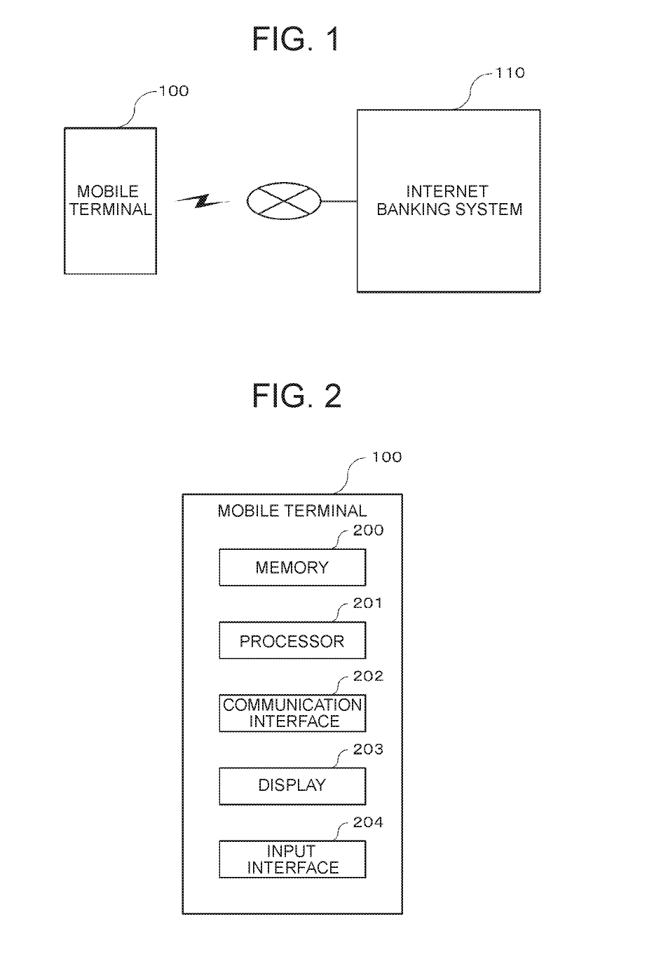

FIG. 1 is a diagram illustrating the configuration of an information processing system according to an embodiment. The information processing system includes a mobile terminal 100 and an Internet banking system 110.

The mobile terminal 100 is, for example, a portable computer, such as a smartphone or a tablet terminal. For example, the mobile terminal 100 can access the Internet through a radio communication network for cellular phones or a wireless LAN (Local Area Network). In the embodiment, the mobile terminal 100 can access the Internet banking system 110. Although only one mobile terminal 100 is illustrated in FIG. 1, there exist many mobile terminals 100 that use the Internet banking system 110.

The Internet banking system 110 is a system for providing various financial services via the Internet, such as balance inquiry and transfer. For example, the Internet banking system 110 includes one or more computers. The Internet banking system 110 can also provide services to the mobile terminal 100 in cooperation with other systems, such as a billing system and a database system.

FIG. 2 is a diagram illustrating an example of the hardware configuration of the mobile terminal 100. As illustrated in FIG. 2, the mobile terminal 100 includes a memory 200, a processor 201, a communication interface 202, a display 203, and an input interface 204.

The memory 200 is a storage area for storing data and programs. The data and programs may be stored in the memory 200 permanently or temporarily. For example, a web browser program as an application used to access the Internet banking system 110 is stored in the memory 200. Further, HTML (HyperText Markup Language) files, style sheets, and the like, used by a web browser to provide a screen display during accessing the Internet banking system 110 using the web browser, are stored in the memory 200. The HTML files and the like used by application programs are also programs for controlling the operation of the mobile terminal 100.

The processor 201 executes programs stored in the memory 200 to implement various functions of the mobile terminal 100. For example, the processor 201 executes the web browser program stored in the memory 200 to implement various functions for using the Internet banking system 110.

The communication interface 202 is an interface for exchanging data with the outside of the mobile terminal 100. For example, the communication interface 202 includes an interface for accessing the radio communication network for cellular phones, an interface for accessing the wireless LAN, and the like. For example, the communication interface 202 may also include an interface for a wired network, such as USB (Universal Serial Bus).

The display 203 is a device for displaying a variety of information, which is, for example, a liquid crystal display or an organic EL (Electroluminescence) display.

The input interface 204 is a device for accepting input from a user. For example, the input interface 204 includes a touch panel provided on the display 203, various input keys, and the like.

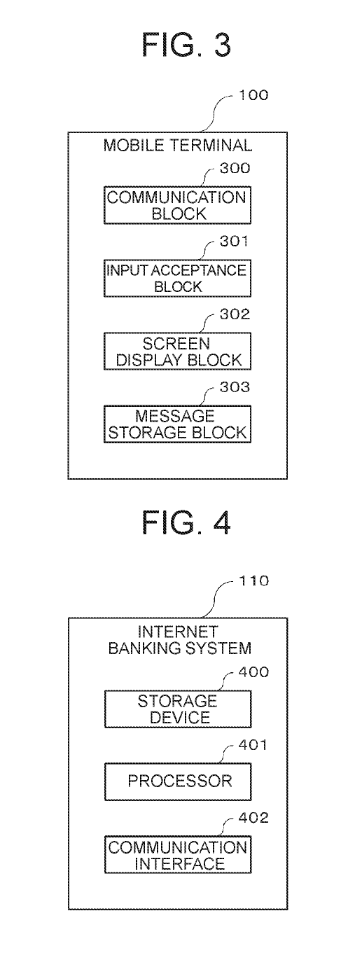

FIG. 3 is a diagram illustrating an example of functional blocks in the mobile terminal 100. The functions illustrated in FIG. 3 are some functions used to use the Internet banking system 110, and not all the functions of the mobile terminal 100. As illustrated in FIG. 3, the mobile terminal 100 includes a communication block 300, an input acceptance block 301, a screen display block 302, and a message storage block 303. For example, each of these blocks is implemented by the processor 201 executing a program stored in the memory 200.

The communication block 300 exchanges data and programs with the Internet banking system 110. For example, the communication block 300 transmits an acquisition request for data and programs to the Internet banking system 110 so that an HTML file, an XML (Extensible Markup Language) file, a style sheet, image data, and the like can be received from the Internet banking system 110 according to the acquisition request. The data and programs received from the Internet banking system 110 are stored in the memory 200.

The input acceptance block 301 accepts various pieces of user input when the user uses the Internet banking system 110. For example, the input acceptance block 301 can accept input of a user ID and a password, and input for specifying a transfer account.

The screen display block 302 displays, on the display 203, various screens for using the Internet banking system 110 based on the HTML file and the like received from the Internet banking system 110.

The message storage block 303 temporarily stores messages received from the Internet banking system 110. For example, the message storage block 303 can store each message with a file name capable of identifying the message.

FIG. 4 is a diagram illustrating an example of the hardware configuration of the Internet banking system 110. As illustrated in FIG. 4, the Internet banking system 110 includes a storage device 400, a processor 401, and a communication interface 402.

The storage device 400 is a storage area such as a memory or a hard disk drive. Data and programs for implementing the Internet banking system 110 are stored in the storage device 400. For example, programs for implementing various functions of the Internet banking system 110, HTML files for displaying screens on the mobile terminal 100 to use the Internet banking system 110, account data for user authentication, various types of data necessary to perform bank transactions, and the like are stored in the storage device 400.

There is no need to pre-store, in the storage device 400, all pieces of data and programs used in the Internet banking system 110. Some pieces of data and programs may be acquired from outside through the communication interface 402 as needed and stored in the storage device 400.

The processor 401 executes programs stored in the storage device 400 to implement various functions in the Internet banking system 110.

The communication interface 402 is an interface for exchanging data with the outside of the Internet banking system 110. For example, the communication interface 402 can include an interface such as Ethernet (registered trademark).

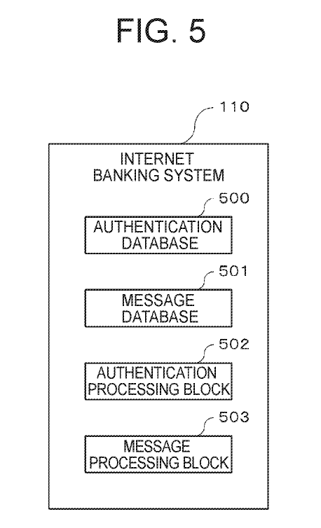

FIG. 5 is a diagram illustrating an example of functional blocks in the Internet banking system 110. As illustrated in FIG. 5, the Internet banking system 110 includes an authentication database 500, a message database 501, an authentication processing block 502, and a message processing block 503. Each of these blocks is, for example, implemented by the processor 401 executing a program stored in the storage device 400. The functions illustrated in FIG. 5 are some functions of the Internet banking system 110, and the Internet banking system 110 can have various other functions.

The authentication database 500 stores account data, such as a user ID, a password, PIN, and the like used to use the Internet banking system 110.

The message database 501 stores messages to be notified to a user. For example, the message database 501 can store a message in association with a user ID of the user to be notified. Further, the message database 501 can store the message in association with a flag indicative of the status (unread/read) of the message.

The authentication processing block 502 performs authentication processing based on the account data stored in the authentication database 500. The authentication processing is performed, for example, at the time of logging in to the Internet banking system 110, at the time of executing a transfer process, and the like.

The message processing block 503 performs processing for notifying the user of a message. Specifically, the message processing block 503 extracts a message to the user from the message database 501 after login to the Internet banking system 110 is completed, and transmits, to the mobile terminal 100, an HTML file and data for displaying the message. Further, based on an instruction from the mobile terminal 100, the message processing block 503 can delete a message stored in the message database 501 or update the status of the message.

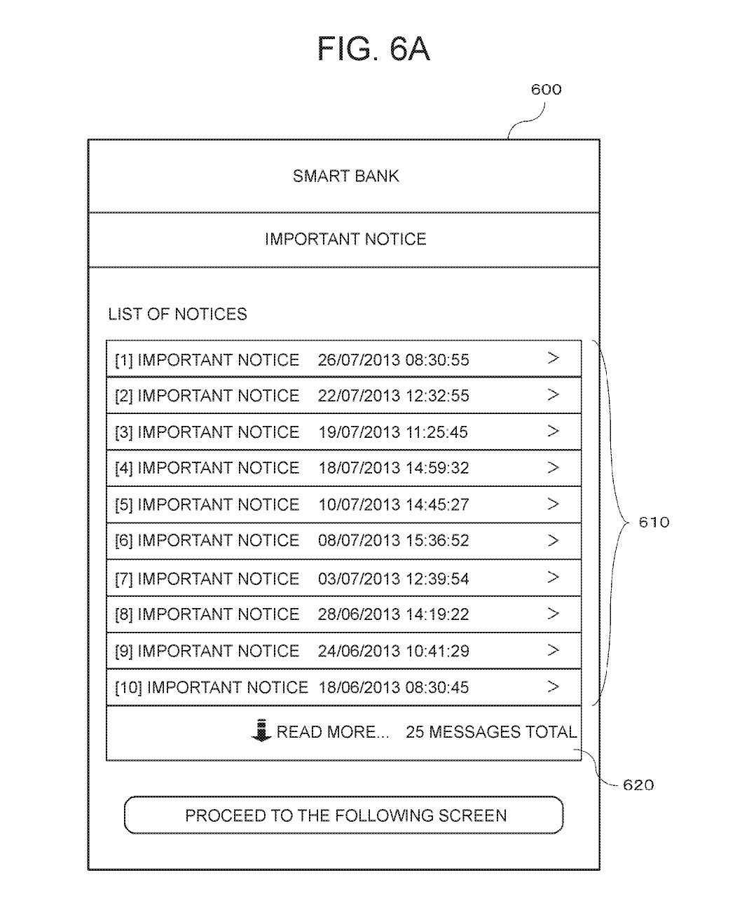

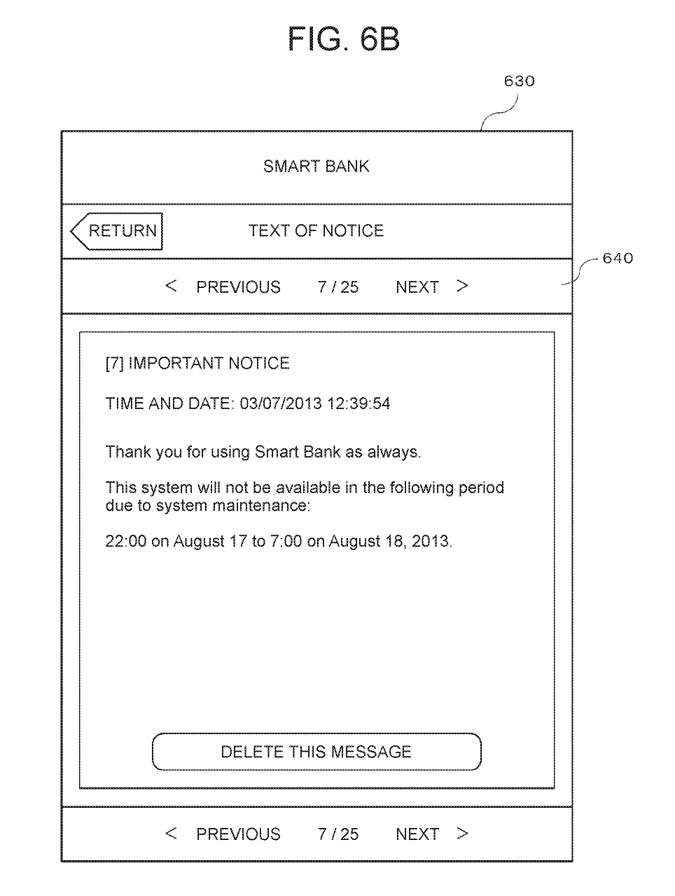

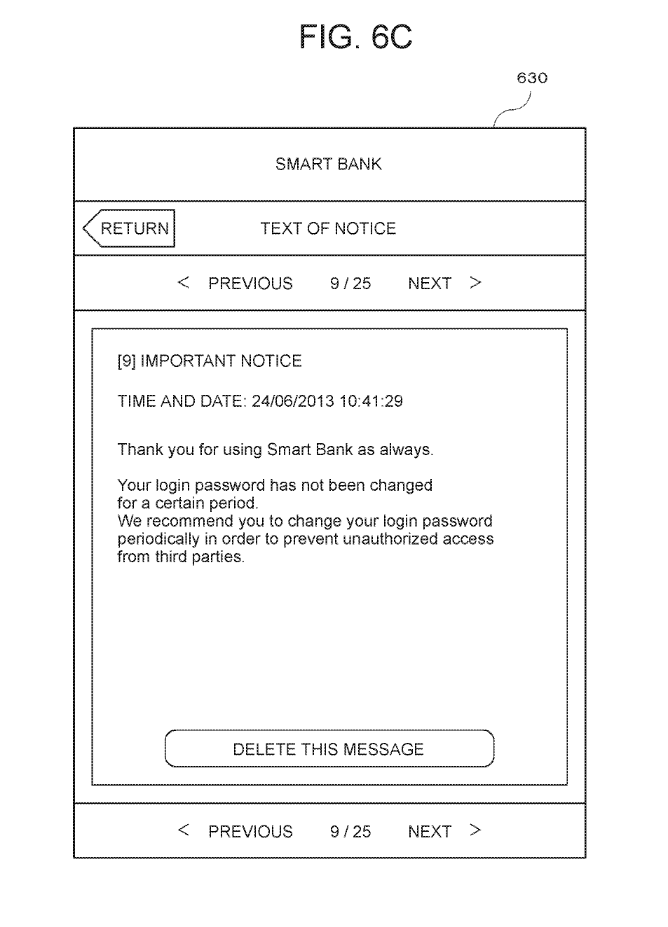

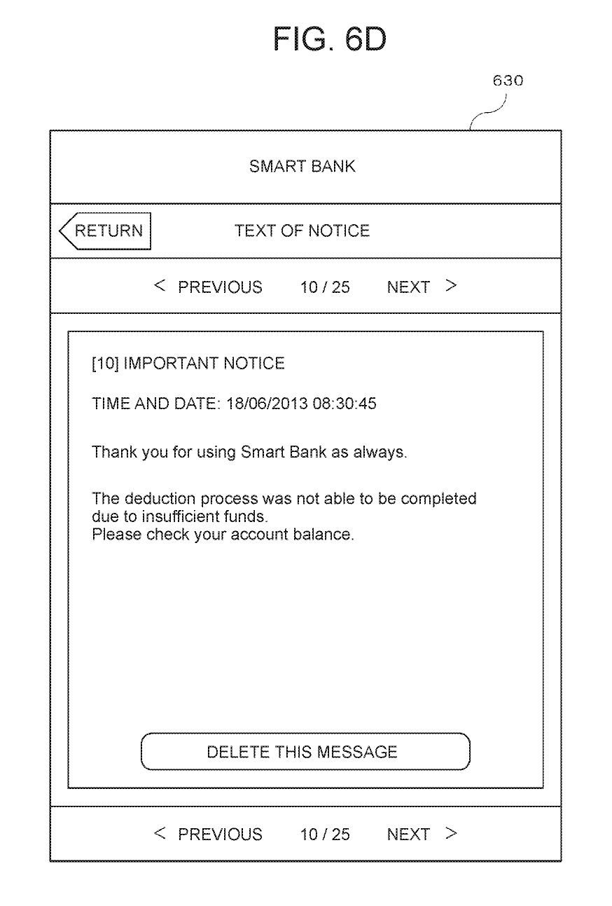

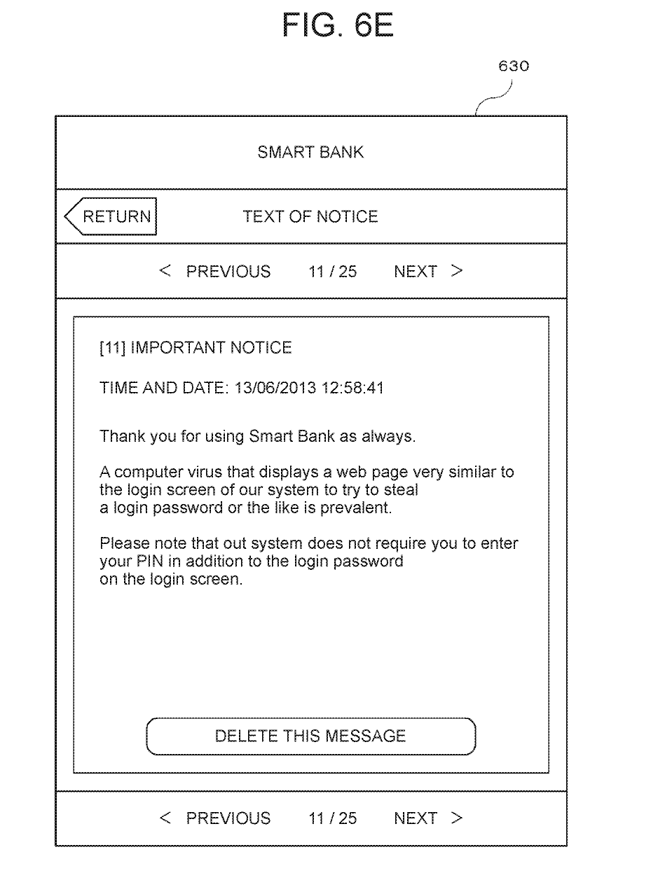

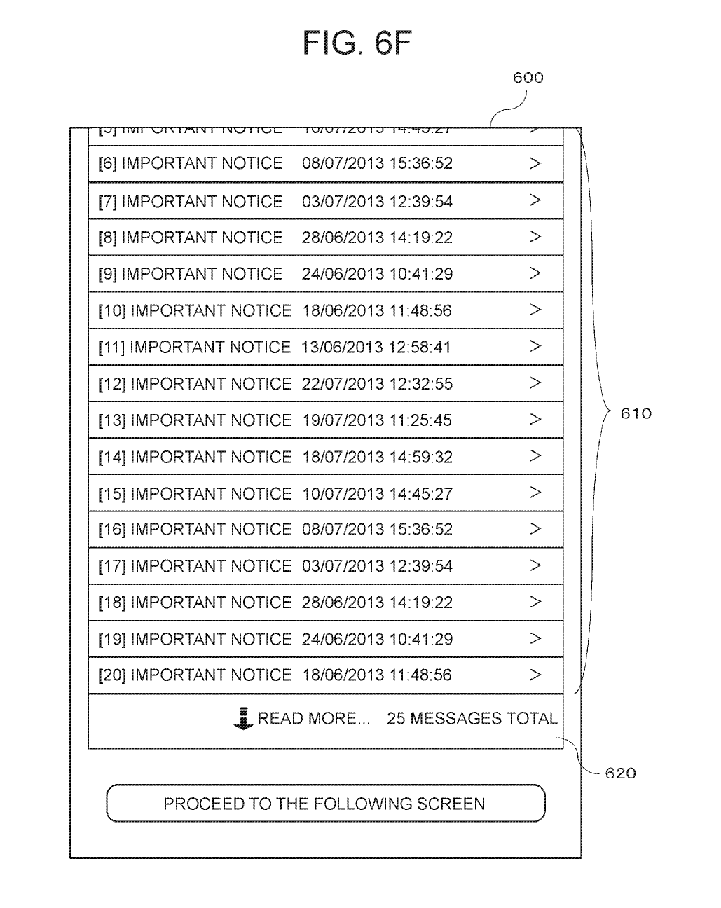

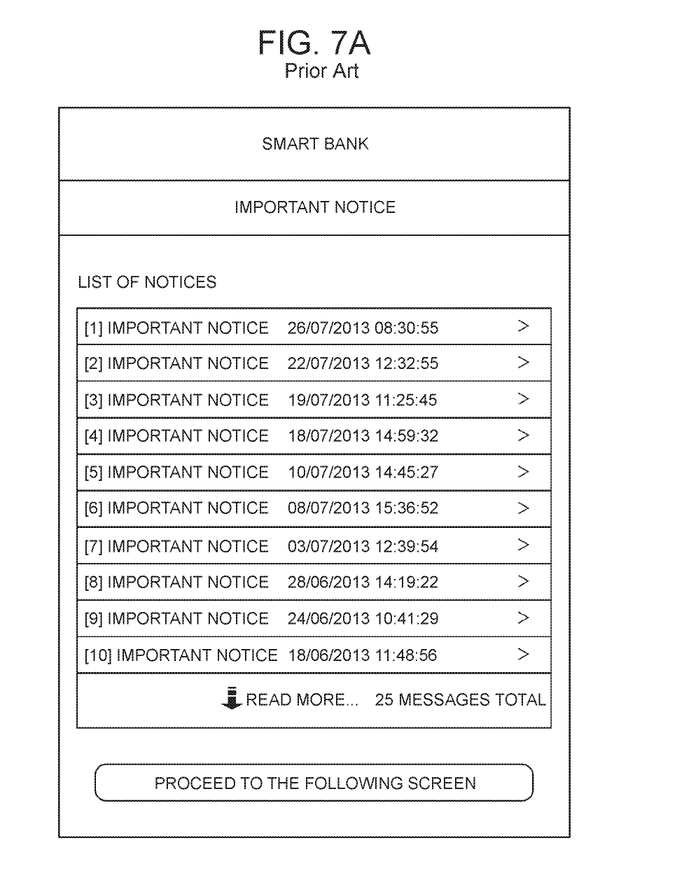

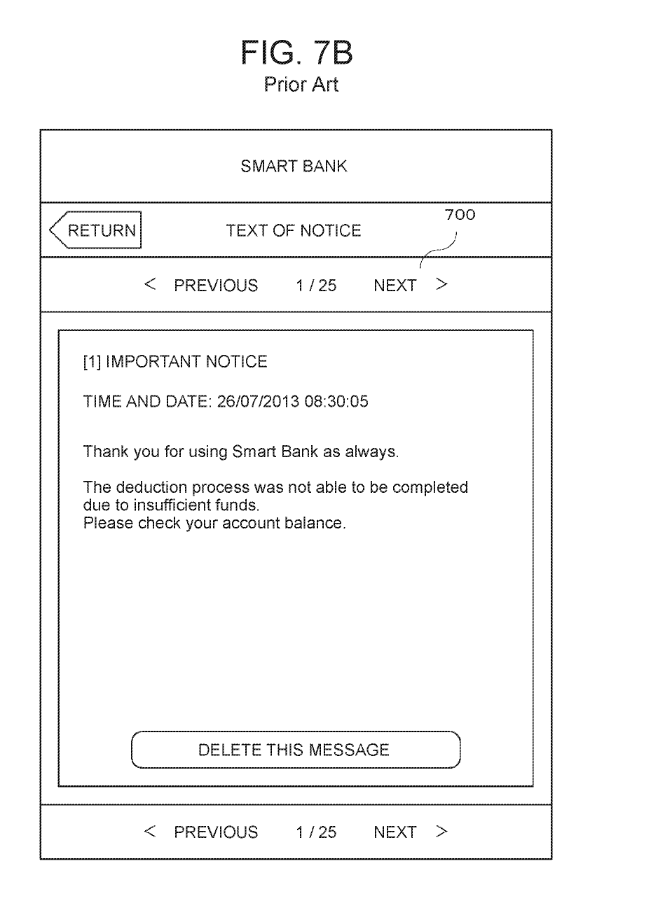

Referring to FIG. 6A through FIG. 6E, examples of message displays in the Internet banking system 110 will be described. FIG. 6A is a diagram illustrating an example of a list screen of messages (notices) displayed on the mobile terminal 100. A screen 600 illustrated in FIG. 6A is displayed, for example, after login to the Internet banking system 110.

For example, after completion of the user authentication by the authentication processing block 502, the screen display block 302 of the mobile terminal 100 transmits, to the Internet banking system 110, an acquisition request for a predetermined number of (e.g., ten) messages (first message group) among all messages (e.g., 25 messages) to the user (initial message acquisition procedure). In response to the request, the message processing block 503 of the Internet banking system 110 extracts, from the message database 501, the predetermined number of messages among all the messages to the user, and transmits, to the mobile terminal 100, an HTML file and data for displaying the messages on the mobile terminal 100. The screen display block 302 of the mobile terminal 100 stores, in the message storage block 303, the messages (the HTML file and data) transmitted from the Internet banking system 110. Then, as illustrated in FIG. 6A, the screen display block 302 displays a list of messages stored in the message storage block 303 (initial message display procedure).

The messages to be notified to the user are extracted for each predetermined number of messages from the message database 501, and transmitted to the mobile terminal 100. In this embodiment, in response to the request from the mobile terminal 100, the message processing block 503 of the Internet banking system 110 extracts ten messages at a time from the message database 501. Therefore, on the screen 600 illustrated in FIG. 6A, a list 610 of first-extracted ten messages is displayed. Note that the messages are ordered based on, for example, the created time and date of each message, the message identifier, or the like. Then, the messages are extracted from the message database 501 and displayed in the list 610 according to this order.

In an area 620 of the screen 600 illustrated in FIG. 6A, the total number of messages (25 messages in the example of FIG. 6A) is displayed. When transmitting the messages to the mobile terminal 100 for the first time, the message processing block 503 of the Internet banking system 110 also transmits data on the total number of messages to the mobile terminal 100. For example, in response to an operation for selecting this area 620 or scrolling the list 610 upward, the screen display block 302 of the mobile terminal 100 can transmit, to the Internet banking system 110, a request for acquiring the next predetermined number of (e.g., ten) messages. In response to the request, the message processing block 503 of the Internet banking system 110 extracts the next predetermined number of (e.g., ten) messages from the message database 501, and transmits the messages to the mobile terminal 100.

When one message is selected in the list 610 of the screen 600 illustrated in FIG. 6A, the screen display block 302 of the mobile terminal 100 displays the selected message content (the text of a notice) as illustrated in FIG. 6B. On a screen 630 illustrated in FIG. 6B, an area 640 for selecting the previous message or the next message is provided. When “previous” is selected in the area 640, the screen display block 302 refers to the message storage block 303 to display the previous message on the screen 630. When “next” is selected in the area 640, the screen display block 302 refers to the message storage block 303 to display the next message on the screen 630.

FIG. 6C is a diagram illustrating a state after “next” is selected twice on the screen 630 of FIG. 6B. Since the seventh message is displayed on the screen 630 of FIG. 6B, the ninth message is displayed on the screen 630 of FIG. 6C. Thus, messages can be displayed sequentially on the screen 630 by selecting “next” sequentially.

In this embodiment, the screen display block 302 of the mobile terminal 100 acquires ten messages at a time and stores the messages in the message storage block 303. In other words, only the first ten messages are acquired among the 25 messages in total when the screen 600 illustrated in FIG. 6A is displayed. Therefore, in order to display the eleventh message by selecting “next” sequentially on the screen 630, the screen display block 302 needs to acquire messages newly from the Internet banking system 110.

For example, it is considered that the next ten messages are acquired at the timing of selecting next” when the tenth message is displayed on the screen 630. However, since communication is required to acquire messages, if the next ten messages are acquired at this timing, a time lag from when “next” is selected in a state where the tenth message is displayed until the eleventh message is displayed will be long.

Therefore, when undisplayed messages stored in the message storage block 303 and to be displayed sequentially become less than or equal to a predetermined number, the screen display block 302 of the mobile terminal 100 acquires the next message group (second message group) from the Internet banking system 110 (additional message acquisition procedure). Specifically, the screen display block 302 of the mobile terminal 100 transmits, to the Internet banking system 110, an acquisition request for the next ten messages, for example, at the timing of displaying the ninth message illustrated in FIG. 6C, i.e., the timing when the number of undisplayed messages to be displayed sequentially becomes one. Then, the screen display block 302 receives messages transmitted from the Internet banking system 110 in response to the request, and stores the messages in the message storage block 303.

In this embodiment, since the messages are ordered, the number of undisplayed messages to be displayed sequentially means the number of messages subsequent in order to the message displayed at present. For example, in the above example, the number of undisplayed messages to be displayed sequentially at the timing of displaying the ninth message as illustrated in FIG. 6C becomes one (only the tenth message) regardless of whether the first to eighth messages have been displayed or not.

Thus, the screen display block 302 acquires the next message group including the eleventh message (ten messages from the eleventh message through the twentieth message) before the display of the eleventh message is actually required. Therefore, when “next” is selected in such a state that the tenth message is displayed on the screen 630 (FIG. 6D), the screen display block 302 can refer to the message storage block 303 to display the eleventh message instantly as illustrated in FIG. 6E (additional message display procedure).

When “return” is selected on the screen 630 after the message group of the eleventh through twentieth is acquired, the screen display block 302 displays the screen 600 that contains the list 610 of the messages (FIG. 6F). As illustrated in FIG. 6F, the list of messages displayed in the list 610 contains the eleventh through twentieth messages additionally acquired, in addition to the first to tenth messages first acquired.

According to the various embodiments, when undisplayed messages to be displayed sequentially become less than or equal to a predetermined number, the screen display block 302 acquires the next message group from the Internet banking system 110. Therefore, when a message in the next message group is displayed, since the message is already acquired, the time lag from when the display of the message is requested until the message is displayed can be shortened. This can improve operability in checking multiple messages acquired via a network.

Note that this embodiment is to facilitate the understanding of the disclosure, and is not to limit the interpretation of the various embodiments. The various embodiments can be modified and improved without departing from the spirit of the disclosure, and equivalents thereof are included in the disclosure.

For example, the messages are ordered in advance in this embodiment, but the various embodiments can also be applied to a case where multiple messages that are not ordered in advance are displayed sequentially in any order. In this case, undisplayed messages to be displayed sequentially mean messages that have not been displayed yet among the acquired messages.

Further, for example, a message to be displayed is a message in the Internet banking system 110 in this embodiment, but the various embodiments can be applied to any message acquired from a server and displayed on the mobile terminal.

In various embodiments according to the present disclosure, including those discussed above, functionalities of the blocks may be implemented in the form of at least one hardware processor configured to carry out these functionalities. That is, the performance of any one or more of the functionalities may be accomplished by a single hardware processor, or be divided, in any manner known to those skilled in the art, among multiple hardware processors.

The various embodiments have been described in detail with particular reference and examples, but it will be understood that variations and modifications can be effected within the spirit and scope of the various embodiments covered by the claims which may include the phrase “at least one of A, B and C” as an alternative expression that means one or more of A, B and C may be used, contrary to the holding in Superguide V. DIRECTV, 69 USPQ2d 1865 (Fed. Cir. 2004).

What is claimed is:

1. A non-transitory computer-readable storage medium storing a screen display program for causing a mobile terminal configured to be communicably connected to a server to execute:
an initial message acquisition procedure that includes acquiring a first message group from among a plurality of messages from the server;
an initial message display procedure that includes displaying messages of the first message group sequentially according to an operation of a user;
an additional message acquisition procedure that includes acquiring, when a number of undisplayed messages to be displayed sequentially among the messages of the first message group becomes less than or equal to a predetermined number, a second message group different from the first message group from among the plurality of messages from the server; and
an additional message display procedure that includes displaying messages of the second message group sequentially following the messages of the first message group.

2. The non-transitory computer-readable storage medium according to claim 1, wherein
the plurality of messages are ordered messages,
the first message group contains continuous messages among the plurality of messages, and
the second message group contains messages following the first message group among the plurality of messages.

3. The storage medium according to claim 2, wherein the plurality of messages are messages in an Internet banking system.

4. The storage medium according to claim 1, wherein the plurality of messages are messages in an Internet banking system.

5. A method, comprising:
in a mobile terminal with a touch screen display that is configured to be communicably connected to a server,
acquiring a first message group from among a plurality of messages from the server;
displaying messages of the first message group sequentially according to an operation of a user;
acquiring, when a number of undisplayed messages to be displayed sequentially among the messages of the first message group becomes less than or equal to a predetermined number, a second message group different from the first message group from among the plurality of messages from the server; and
displaying messages of the second message group sequentially following the messages of the first message group.

6. The method according to claim 5, wherein the plurality of messages are messages in an Internet banking system.

7. The method according to claim 5, wherein
the plurality of messages are ordered messages,
the first message group contains continuous messages among the plurality of messages, and
the second message group contains messages following the first message group among the plurality of messages.

8. The method according to claim 7, wherein the plurality of messages are messages in an Internet banking system.
